(19) United States
(12) Patent Application Publication
(10) Pub. No.: US 2010/0291457 A1
(43) Pub. Date: Nov. 18, 2010

(54) HEAT EXCHANGING APPARATUS

(75) Inventor: Cheng Wang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: YOUNG GREEN ENERGY CO., Hsinchu County (TW)

(21) Appl. No.: 12/581,161

(22) Filed: Oct. 19, 2009

(30) Foreign Application Priority Data
May 12, 2009 (TW) 98115707

(51) Int. Cl. H01M 8/02

(52) U.S. Cl. 429/438

(57) ABSTRACT

A heat exchanging apparatus adapted to a fuel cell system includes a water-collecting tank, at least one first pipe, at least one second pipe, an airflow generator, and a housing. The water-collecting tank has a fluid outlet and is adapted to be communicated with a fuel-mixing tank of the fuel cell system. The first pipe is adapted to receive vapor produced by a cathode of a fuel cell module of the fuel cell system. The second pipe is communicated between the first pipe and the water-collecting tank, and is communicated with the outside through the fluid outlet. The airflow generator is adapted to generate a cooling airflow, flowing through outside the second pipe, and performing heat exchange with the vapor inside the second pipe. The housing has a first channel with the first pipe disposed therein and a second channel with the second pipe disposed therein.

### CROSS-REFERENCE TO RELATED APPLICATION

This application claims the priority benefit of Taiwan application serial no. 98115707, filed on May 12, 2009. The entirety of the above-mentioned patent application is hereby incorporated by reference herein and made a part of specification.

### BACKGROUND OF THE INVENTION

1. Field of the Invention

The present invention generally relates to a heat exchanging apparatus, in particular, to a heat exchanging apparatus adapted to a fuel cell module.

2. Description of Related Art

A fuel cell is advantageous in having high efficiency, low noise, and no pollution, and is an energy technique satisfying the trend of the times. The fuel cell may be classified into various types, in which proton exchange membrane fuel cell (PEMFC) and direct methanol fuel cell (DMFC) are commonly used. Taking the DMFC for example, a fuel cell module of the DMFC is composed of a proton exchange membrane and a cathode and an anode respectively disposed on two sides of the proton exchange membrane.

Patents related to the fuel cell are, for example, U.S. Pat. No. 20070114005 and Taiwan Patent No. 1244794, 200814416, 200835037, and 200847516. In addition, a patent related to a heat pipe is, for example, Taiwan Patent No. I305823.

### SUMMARY OF THE INVENTION

Accordingly, the present invention is directed to a heat exchanging apparatus capable of recycling vapor produced by a reaction of a fuel cell module.

Other objectives and efficacies of the present invention are further illustrated in the technical features of the invention.

In order to achieve one or a portion of or all of the objects or other objects, the present invention provides a heat exchanging apparatus adapted to a fuel cell system in an embodiment. The heat exchanging apparatus includes a water-collecting tank, at least one first pipe, at least one second pipe, an airflow generator, and a housing. The water-collecting tank has a fluid outlet and is adapted to be communicated with a fuel-mixing tank of the fuel cell system. The first pipe is adapted to receive vapor produced by a cathode of a fuel cell module of the fuel cell system. The second pipe is communicated between the first pipe and the water-collecting tank, and is communicated with the outside through the fluid outlet. The airflow generator is adapted to generate a cooling airflow. The cooling airflow flows through an external part of the second pipe, and performs heat exchange with the vapor in an internal part of the second pipe, so that a part of the vapor is condensed into liquid water and flows to the water-collecting tank. The housing has a first channel and a second channel. The first pipe is disposed in the first channel, the second pipe is disposed in the second channel, and an airflow flowing through the first channel and an external part of the first pipe is heated by the vapor in an internal part of the first pipe, so as to be supplied to the fuel cell system.

According to the embodiment of the present invention, in the heat exchanging apparatus, the cooling airflow performs heat exchange with the vapor in the internal part of the second pipe, such that a part of the vapor is condensed into liquid water and flows to the water-collecting tank. The liquid water in the water-collecting tank may be supplemented to the fuel-mixing tank, so as to achieve a water recycling effect.

Other objectives, features and advantages of the present invention will be further understood from the further technological features disclosed by the embodiments of the present invention wherein there are shown and described preferred embodiments of this invention, simply by way of illustration of modes best suited to carry out the invention

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a heat exchanging apparatus adapted to a fuel cell system according to an embodiment of the present invention.

FIG. 2 is a perspective view of the heat exchanging apparatus according to an embodiment of the present invention.

FIG. 3 is an exploded view of FIG. 2.

FIG. 4 is a perspective view of the heat exchanging apparatus in FIG. 2 from another viewing angle.

FIG. 5 is an exploded view of FIG. 4.

FIG. 6 is a top view of the heat exchanging apparatus in FIG. 2.

FIG. 7 is a cross-sectional view taken along line A-A in FIG. 6.

FIG. 8 is a cross-sectional view of a second pipe according to another embodiment of the present invention.

FIG. 9 is a cross-sectional view taken along line B-B in FIG. 6.

FIG. 10 is a side view of the heat exchanging apparatus in FIG. 2.

FIG. 11 is a cross-sectional view taken along line C-C in FIG. 10.

FIG. 12 is a schematic view of a capillary structure of the second pipe.

FIG. 13 is a cross-sectional view taken along line D-D in FIG. 10.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional ten iinology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

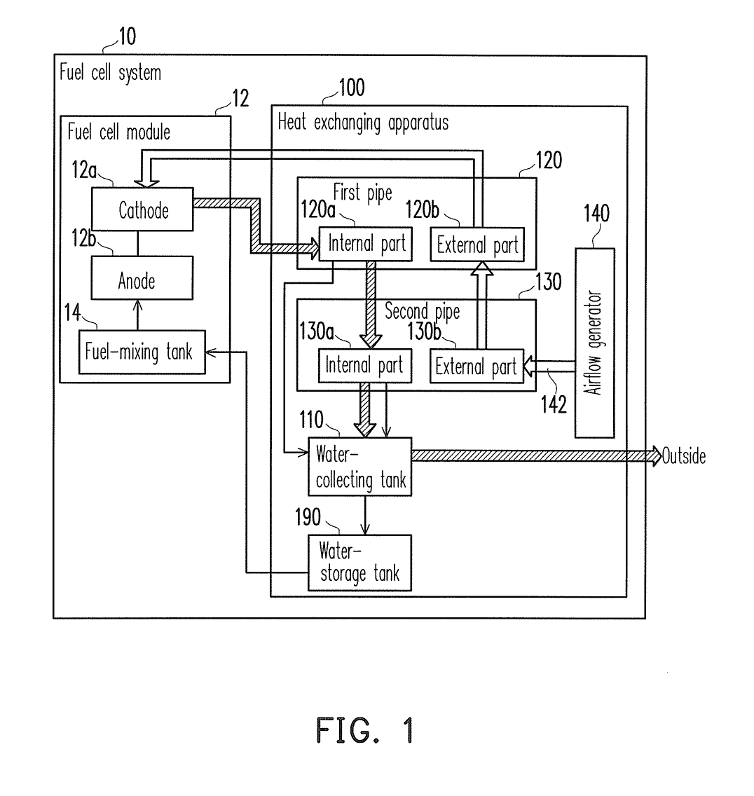

FIG. 1 is a block diagram of a heat exchanging apparatus adapted to a fuel cell system according to an embodiment of the present invention. Referring to FIG. 1, a heat exchanging apparatus 100 is adapted to a fuel cell system 10. The fuel cell system 10 includes a fuel cell module 12 and a fuel-mixing tank 14. The fuel cell module 12 is used to perform a chemical reaction, and the fuel-mixing tank 14 is used to store a fuel. In this embodiment, the fuel is, for example, a methanol (CH₃OH) aqueous solution. The heat exchanging apparatus 100 may recycle vapor produced by the reaction of the fuel cell module 12.

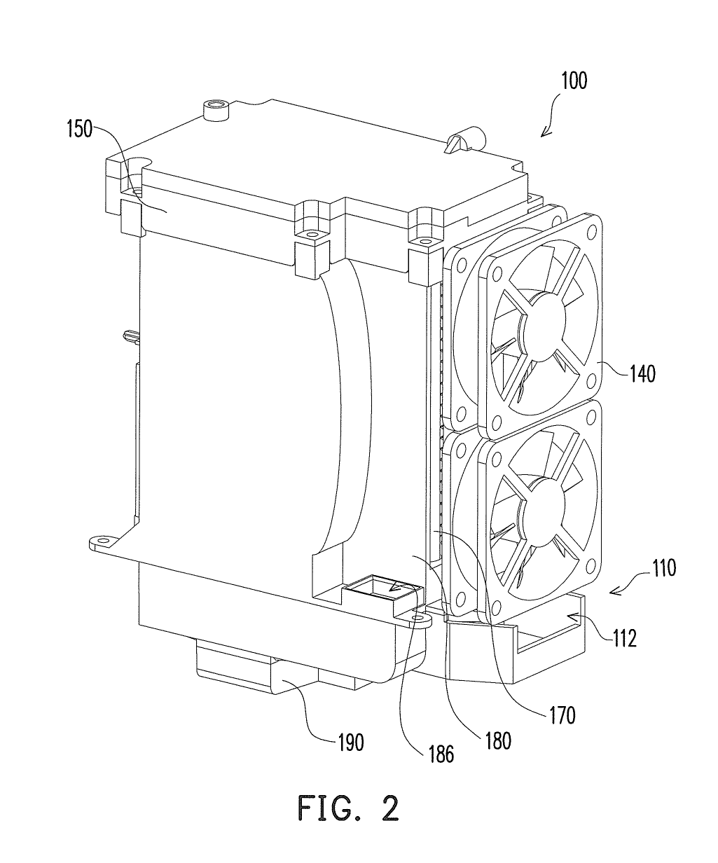

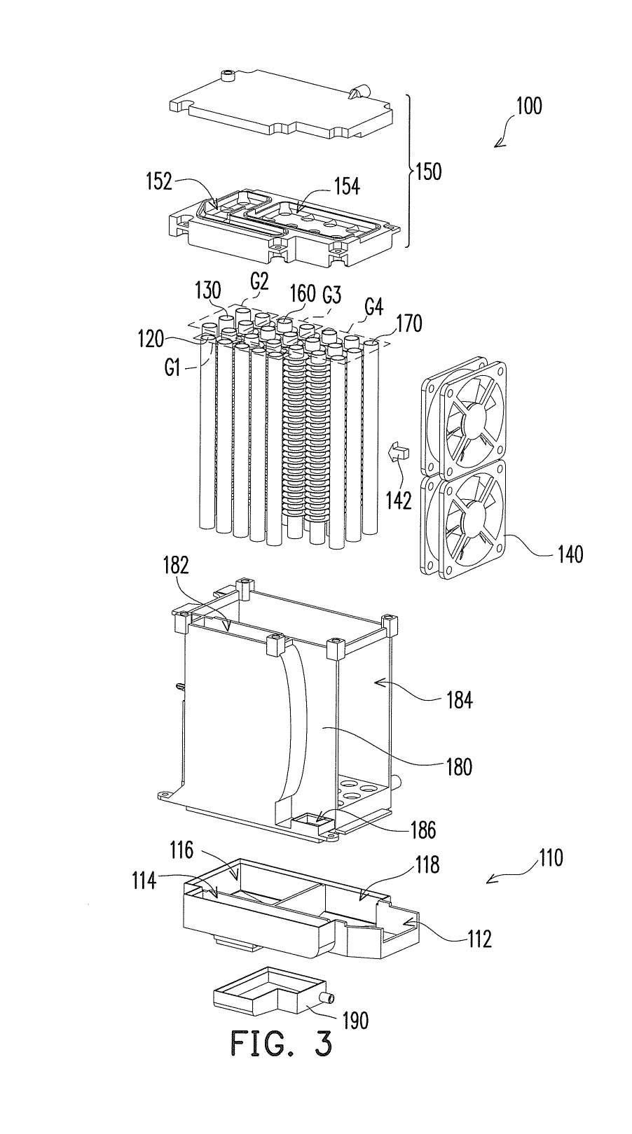

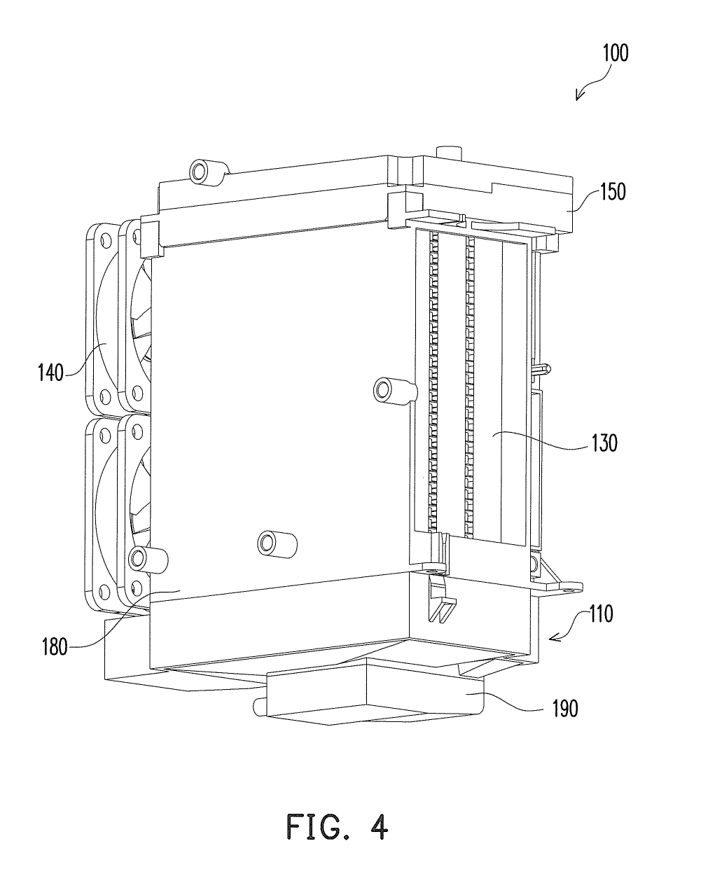

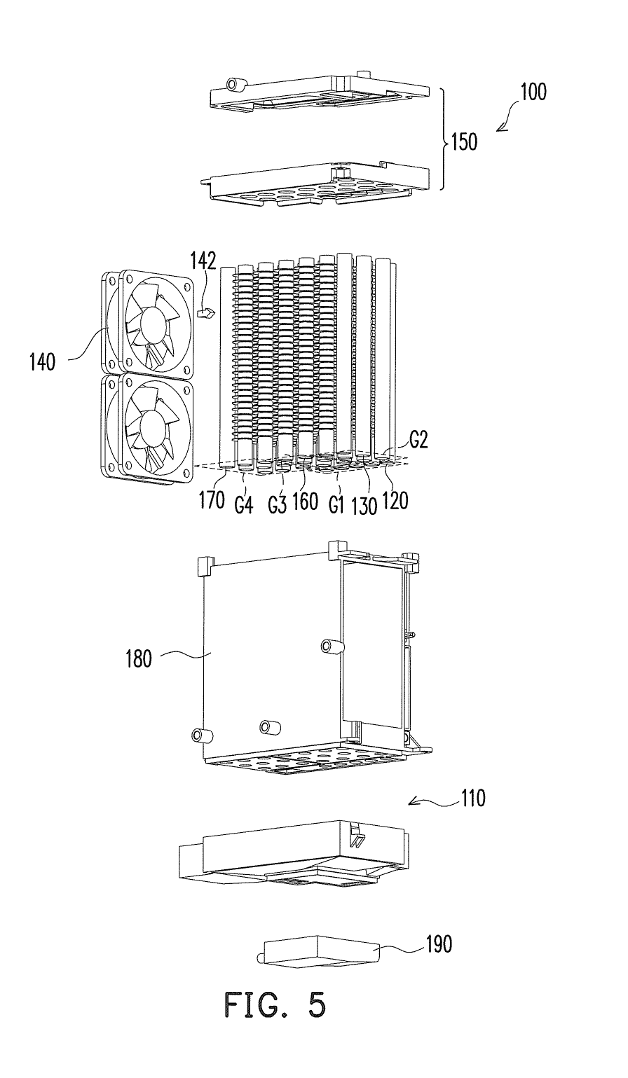

FIG. 2 is a perspective view of the heat exchanging apparatus according to an embodiment of the present invention, and FIG. 3 is an exploded view of FIG. 2. FIG. 4 is a perspective view of the heat exchanging apparatus in FIG. 2 from another viewing angle, and FIG. 5 is an exploded view of FIG. 4. Referring to FIGS. 1 to 5, the heat exchanging apparatus 100 includes a water-collecting tank 110, at least one first pipe 120, at least one second pipe 130, an airflow generator 140, and a housing 180. The water-collecting tank 110 is disposed on one side of the first pipe 120 and the second pipe 130, and has a fluid outlet 112. The water-collecting tank 110 is also adapted to be communicated with the fuel-mixing tank 14.

The first pipe 120 is adapted to receive vapor produced by a cathode 12a of the fuel cell module 12. The second pipe 130 is communicated between the first pipe 120 and the water-collecting tank 110, and is communicated with the outside through the fluid outlet 112. Therefore, when the fuel cell module 12 performs a reaction, the vapor produced by the cathode 12a flows through an internal part 120a of the first pipe 120, an internal part 130a of the second pipe 130, and the water-collecting tank 110 in sequence, and is dissipated to the outside through the fluid outlet 112.

The airflow generator 140 is adapted to generate a cooling airflow 142. In this embodiment, the airflow generator 140 may be an axial fan. The cooling airflow 142 flows through an external part 130b of the second pipe 130, and performs heat exchange with the vapor in the internal part 130a of the second pipe 130. Therefore, the vapor in the internal part 130a of the second pipe 130 is cooled by the cooling airflow 142, and a part of the vapor is condensed into liquid water and flows to the water-collecting tank 110. In addition, after flowing to the water-collecting tank 110 under the gravity effect, the liquid water further flows to the fuel-mixing tank 14, and is supplemented to an anode 12b of the fuel cell module 12, so as to achieve a water recycling effect.

In another aspect, after flowing through the external part 130b of the second pipe 130, the cooling airflow 142 is guided and supplemented to the cathode 12a. It should be noted that the cooling airflow 142 may be heated by the vapor in the internal part 130a of the second pipe 130, and result in a higher temperature. Therefore, the cathode 12a obtains the cooling airflow 142 at a relatively higher temperature as a reactant, and the reaction speed of the fuel cell module 12 is effectively improved, such that the fuel cell system 10 achieves a better power generating efficiency.

In this embodiment, the heat exchanging apparatus 100 further includes a flow passage element 150, at least one third pipe 160, and at least one fourth pipe 170. The third pipe 160 is communicated with the second pipe 130 through the water-collecting tank 110, and the fourth pipe 170 is communicated between the third pipe 160 and the water-collecting tank 110. The flow passage element 150 is disposed on the other side of the pipes 120, 130, 160, and 170 relative to the water-collecting tank 110, and has a first flow passage 152 and a second flow passage 154. The first pipe 120 is communicated with the second pipe 130 through the first flow passage 152, and the third pipe 160 is communicated with the fourth pipe 170 through the second flow passage 154.

In addition, the water-collecting tank 110 includes a first sub-water-collecting tank 114, a second sub-water-collecting tank 116, and a third sub-water-collecting tank 118. The first sub-water-collecting tank 114 is communicated with the first pipe 120, and the first pipe 120 is adapted to receive the vapor produced by the cathode 12a through the first sub-water-collecting tank 114. The second pipe 130 is communicated with the third pipe 160 through the second sub-water-collecting tank 116. The third sub-water-collecting tank 118 is communicated with the fourth pipe 170 and has the fluid outlet 112.

Particularly, the vapor produced by the reaction of the cathode 12a of the fuel cell module 12 is driven by an airflow driver (not shown) to leave the cathode 12a and enter the first pipe 120. In this embodiment, the vapor flows through the first sub-water-collecting tank 114 via an air inlet 186 of the housing 180, and then flows into the first pipe 120. The vapor in the first pipe 120 flows through the first flow passage 152, the second pipe 130, the second sub-water-collecting tank 116, the third pipe 160, the second flow passage 154, the fourth pipe 170, and the third sub-water-collecting tank 118 in sequence, and is finally dissipated to the outside through the fluid outlet 112. During the process, the vapor is condensed into water for being recycled.

In this embodiment, the housing 180 has a first channel 182 and a second channel 184. The first pipe 120 is disposed in the first channel 182, and the second pipe 130, the third pipe 160, and the fourth pipe 170 are all disposed in the second channel 184. The first channel 182 is communicated with the second channel 184. Therefore, the cooling airflow 142 generated by the airflow generator 140 firstly flows through the second channel 184, and is heated by the vapor in the internal parts of the second pipe 130, the third pipe 160, and the fourth pipe 170. Then, the cooling airflow 142 flows through the first channel 182 and the external part 120b of the first pipe 120, and is heated by the vapor in the internal part 120a of the first pipe 120.

Therefore, the cooling airflow 142 sequentially flows through the second channel 184 and the first channel 182, and is heated twice. In this manner, the cooling airflow 142 at a relatively higher temperature is supplied to the cathode 12a as the reactant, so that the fuel cell module 12 achieves a better reacting efficiency.

In addition, in this embodiment, the first pipe 120, the second pipe 130, the third pipe 160, and the fourth pipe 170 are disposed in parallel with one another, and thus the heat exchanging apparatus 100 has a relatively small volume. Further, the plurality of first pipes 120, the plurality of second pipes 130, the plurality of third pipes 160, and the plurality of fourth pipes 170 may respectively form a first pipe group G1, a second pipe group G2, a third pipe group G3, and a fourth pipe group G4, so as to improve the heat exchanging efficiency.

It should be noted that, in order to enable the heat exchanging apparatus 100 to achieve a better heat exchanging effect, the third pipe 160 and the fourth pipe 170 are added to the heat exchanging apparatus 100 of this embodiment, thereby increasing the contact area of the cooling airflow 142. Therefore, the vapor in the second pipe 130 is more rapidly condensed into liquid water as the cooling airflow 142 flows through the second pipe 130, the third pipe 160, and the fourth pipe 170, and then flows to the water-collecting tank 110.

In another aspect, the cooling airflow 142 flows through external parts of the third pipe 160 and the fourth pipe 170, and is heated by the vapor in internal parts of the third pipe 160 and the fourth pipe 170, so as to be supplied to the cathode 12a. However, this embodiment is not intended to limit the present invention. For example, in another embodiment that is not shown, the heat exchanging apparatus 100 only has the first pipe 120 and the second pipe 130, and does not have the third pipe 160 and the fourth pipe 170 in accordance with different design requirements. Therefore, the second flow passage 154, the second sub-water-collecting tank 116, and the third sub-water-collecting tank 118 matching with the third pipe 160 and the fourth pipe 170 may also be removed.

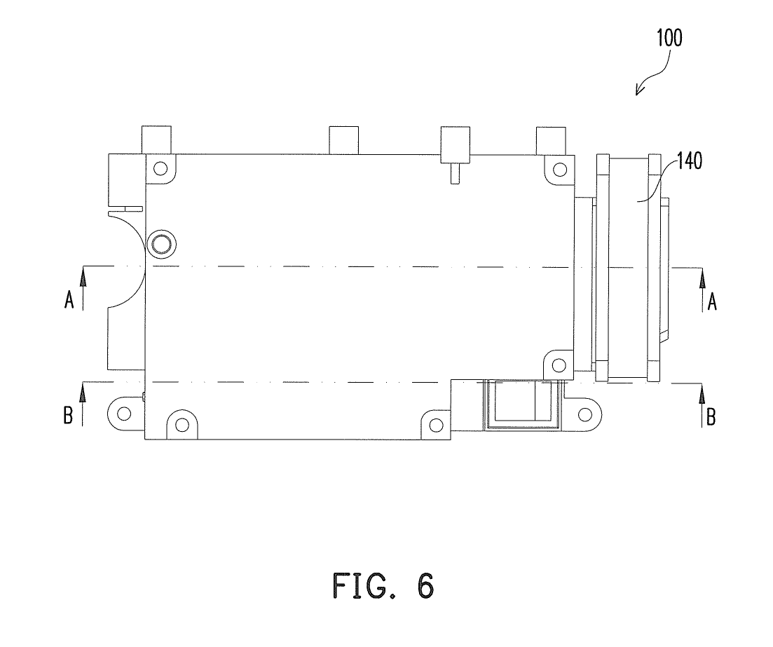

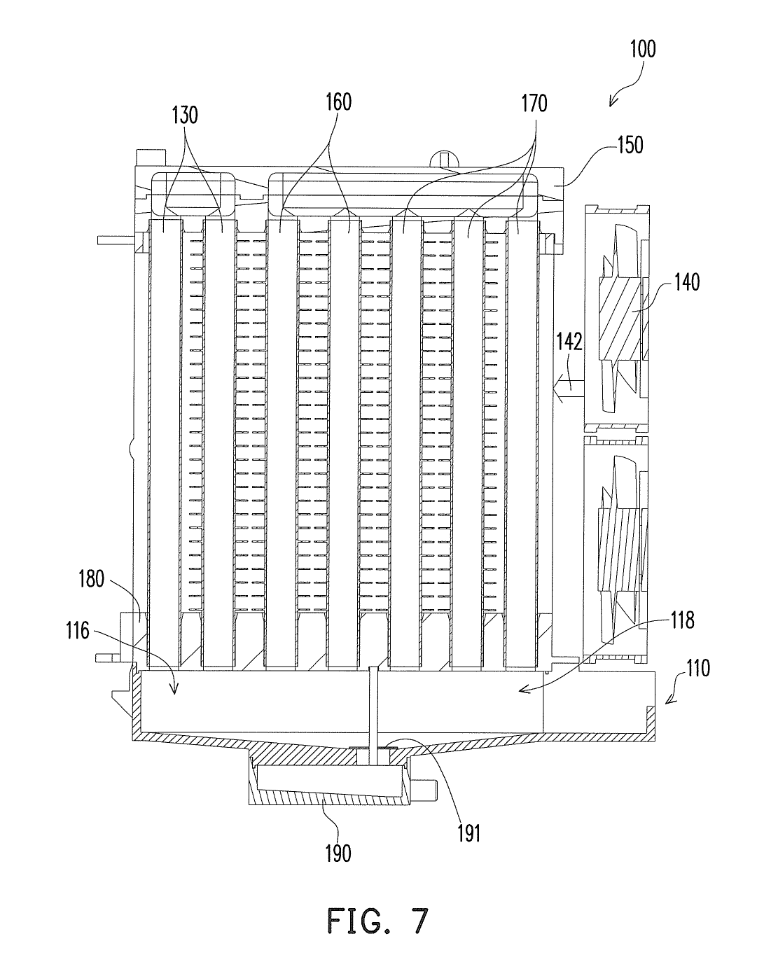

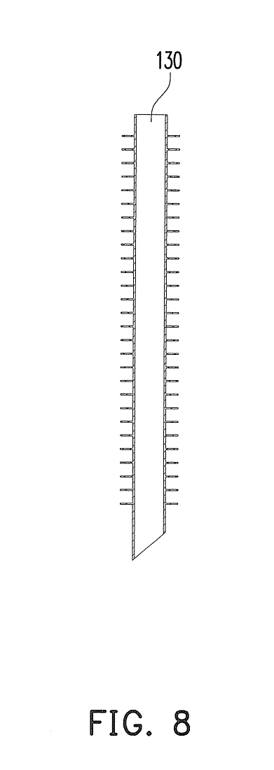

FIG. 6 is a top view of the heat exchanging apparatus in FIG. 2, and FIG. 7 is a cross-sectional view taken along line A-A in FIG. 6. Referring to FIGS. 6 and 7, in this embodiment, one end of the second pipe 130, the third pipe 160, and the fourth pipe 170 facing the water-collecting tank 110 is a flat end. FIG. 8 is a cross-sectional view of the second pipe according to another embodiment of the present invention. Referring to FIG. 8, in another embodiment, one end of the second pipe 130 facing the water-collecting tank 110 is a miter cut end. Therefore, when the vapor in the second pipe 130 is condensed into liquid water, the liquid water may quickly flow to the second sub-water-collecting tank 116. Definitely, in other embodiments, one end of the third pipe 160 and the fourth pipe 170 facing the water-collecting tank 110 may also be a miter cut end, which is not limited in the present invention.

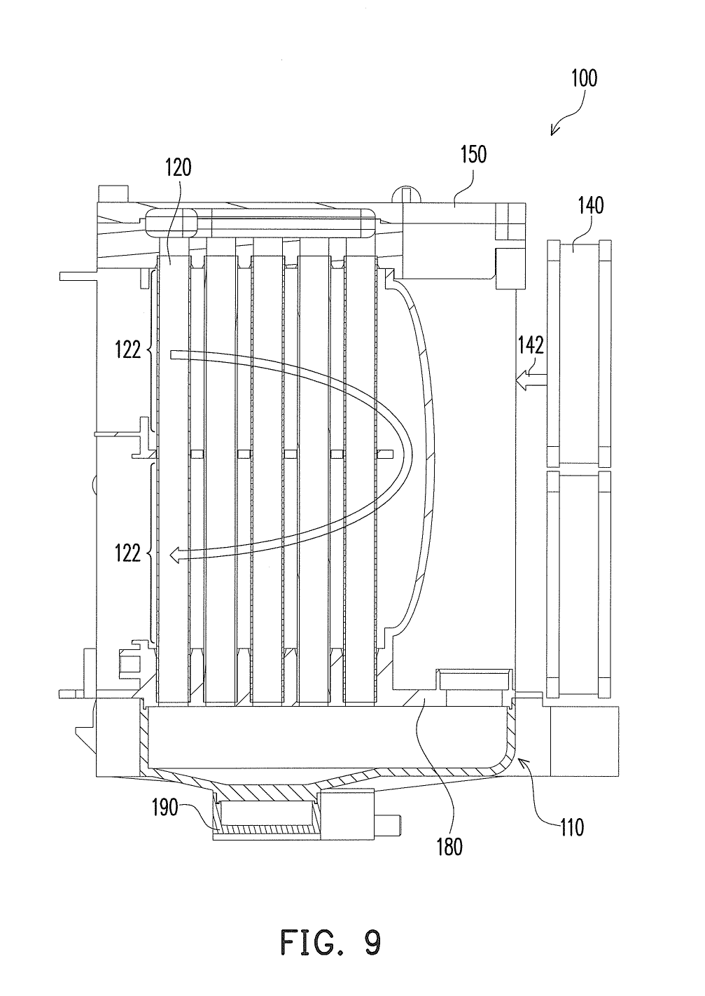

FIG. 9 is a cross-sectional view taken along line B-B in FIG. 6. Referring to

FIGS. 2, 6, 7, and 9, in this embodiment, the first pipe 120 has a plurality of segments 122, and the first channel 182 passes through the segments 122 in sequence. In particular, after flowing through the second channel 184, the cooling airflow 142 generated by the airflow generator 140 is diverted by a fan or a baffle (not shown), and enters the first channel 182. The cooling airflow 142 first flows through the upper half segment 122 of the first pipe 120, and then flows through the lower half segment 122 of the first pipe 120, such that the first channel 182 is approximately a U-shape channel, so as to perform heat exchange with the first pipe 120 for many times.

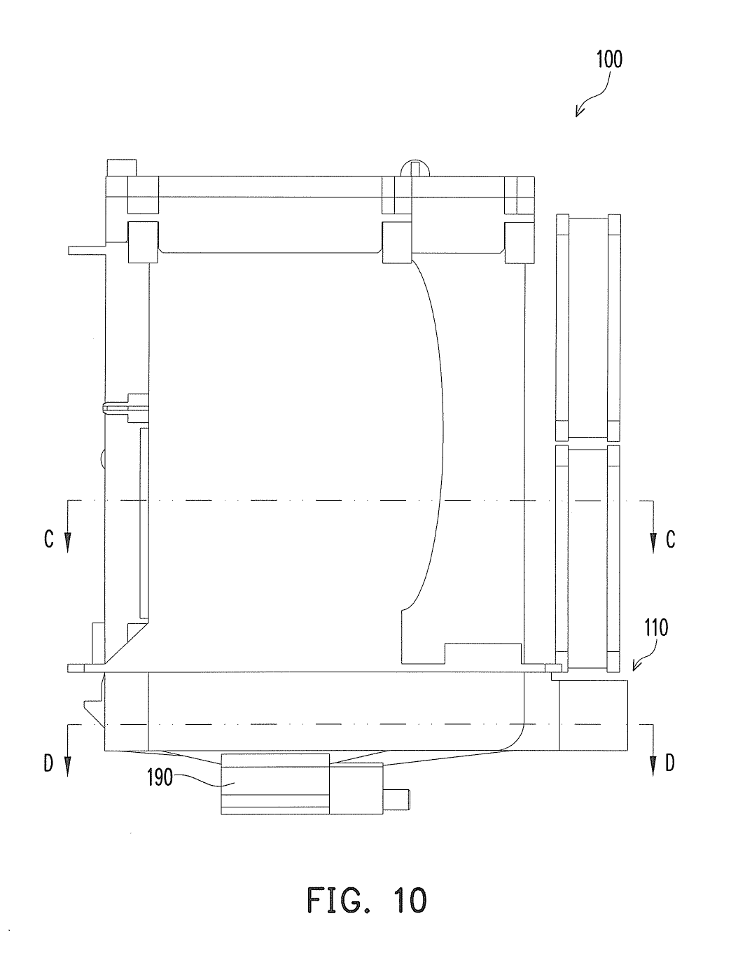

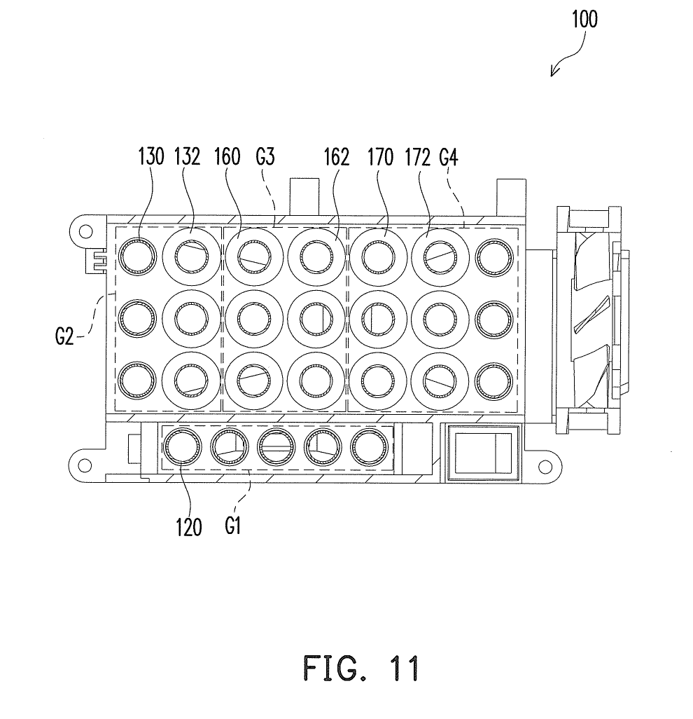

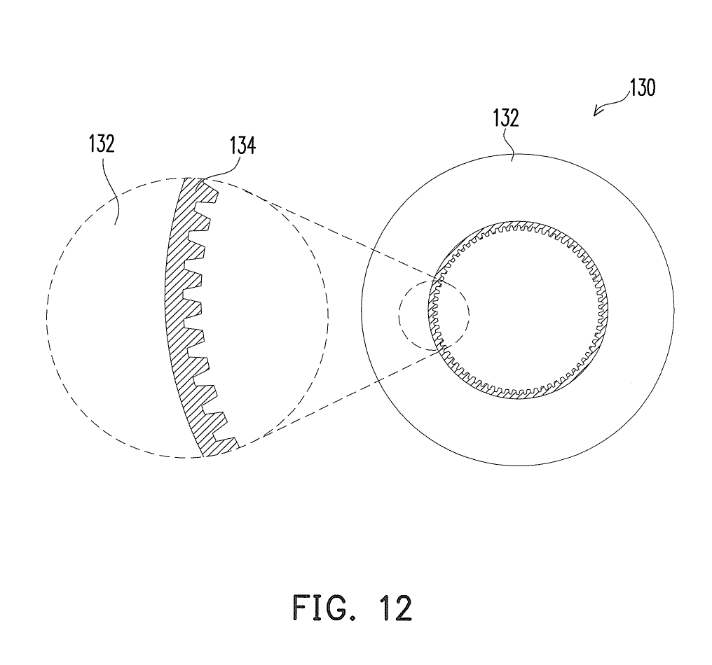

FIG. 10 is a side view of the heat exchanging apparatus in FIG. 2, FIG. 11 is a cross-sectional view taken along line C-C in FIG. 10, and FIG. 12 is a schematic view of a capillary structure of the second pipe. Referring to FIGS. 10, 11, and 12, in this embodiment, an outer surface of the second pipe 130 has a plurality of fins 132, for increasing the heat exchanging area. Similarly, an outer surface of the third pipe 160 and the fourth pipe 170 may be respectively provided with a plurality of fins 162 and 172, so as to improve the heat exchanging efficiency.

In addition, an inner surface of the second pipe 130 has a capillary structure 134, and the liquid water in the second pipe 130 is adsorbed to a pipe wall by the capillary structure 134, such that the heat may be quickly dissipated to the outside through the second pipe 130, thus increasing the condensing speed. It should be noted that the internal surface area of the second pipe 130 is enlarged by the capillary structure 134, so as to prevent the liquid water from blocking the second pipe 130. In addition, the capillary structure 134 may also be disposed on the inner surfaces of the first pipe 120, the third pipe 160, and the fourth pipe 170. Further, in this embodiment, the capillary structure 134 is, for example, a slot, a sintered structure, a metal mesh structure, or a combination thereof.

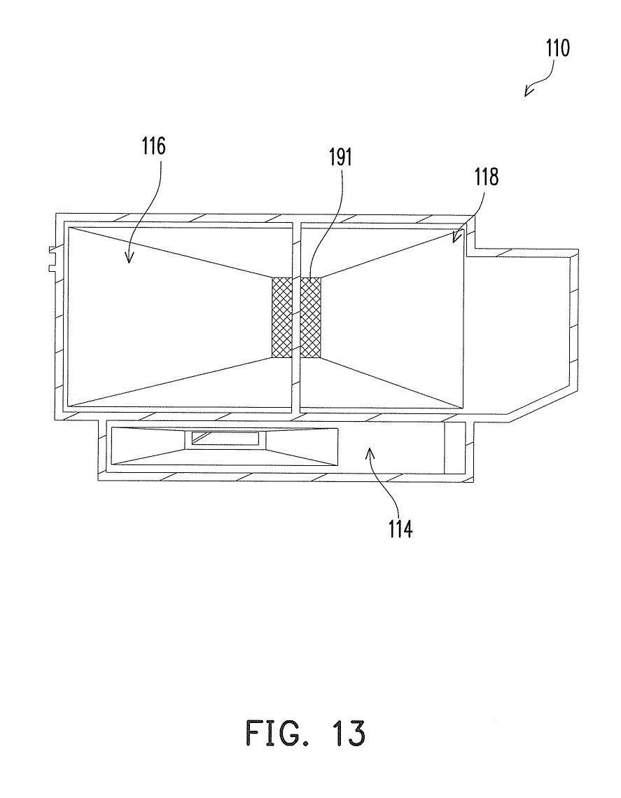

FIG. 13 is a cross-sectional view taken along line D-D in FIG. 10. Referring to FIGS. 2, 10, and 13, in this embodiment, the heat exchanging apparatus 100 further includes a water-storage tank 190 and a blocking element 191. The water-storage tank 190 is disposed between the water-collecting tank 110 and the fuel-mixing tank 14 (as shown in FIG. 1) and is located below the water-collecting tank 110. The water-storage tank 190 is communicated between the water-collecting tank 110 and the fuel-mixing tank 14, so as to supplement the liquid water flowing from the water-collecting tank 110 to the fuel-mixing tank 14.

The blocking element 191 is disposed between the water-collecting tank 110 and the water-storage tank 190. In this embodiment, the blocking element 191 is disposed among the second sub-water-collecting tank 116, the third sub-water-collecting tank 118, and the water-storage tank 190. The blocking element 191 allows the liquid water in the second sub-water-collecting tank 116 and the third sub-water-collecting tank 118 to pass through the blocking element 191 and flow to the water-storage tank 190, and blocks the vapor in the second sub-water-collecting tank 116 and the third sub-water-collecting tank 118 from flowing to the water-storage tank 190. Therefore, the vapor in the second sub-water-collecting tank 116 and the third sub-water-collecting tank 118 is dissipated to the outside through the fluid outlet 112. In addition, in this embodiment, a material of the blocking element 191 may be non-woven fabrics.

To sum up, according to the embodiment of the present invention, in the heat exchanging apparatus, the cooling airflow performs heat exchange with the vapor in the internal part of the second pipe, such that a part of the vapor is condensed into liquid water and flows to the water-collecting tank. The liquid water in the water-collecting tank is supplemented to the anode of the fuel cell module as the reactant, so as to achieve a water recycling effect. In addition, the cooling airflow flows through the second channel and the first channel, and is heated twice to result in a relatively higher temperature. Then, through the heat exchanging apparatus, the cooling airflow at a higher temperature is supplemented to the cathode, and the cathode receives the high temperature cooling airflow as the reactant, so as to improve the reacting efficiency of the fuel cell module.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A heat exchanging apparatus, adapted to a fuel cell system, the heat exchanging apparatus comprising:
a water-collecting tank comprising a fluid outlet, and adapted to be communicated with a fuel-mixing tank of the fuel cell system;
at least one first pipe adapted to receive vapor produced by a cathode of a fuel cell module of the fuel cell system;
at least one second pipe communicated between the first pipe and the water-collecting tank, and communicated with the outside through the fluid outlet;
an airflow generator adapted to generate a cooling airflow, wherein the cooling airflow is capable of flowing through an external part of the second pipe, and is capable of performing heat exchange with the vapor in an internal part of the second pipe, so that a part of the vapor is condensed into liquid water and is capable of flowing to the water-collecting tank; and
a housing comprising a first channel and a second channel, wherein the first pipe is disposed in the first channel, the second pipe is disposed in the second channel, and an airflow flowing through the first channel and an external part of the first pipe is heated by the vapor in an internal part of the first pipe, so as to be supplied to the fuel cell system.

2. The heat exchanging apparatus according to claim 1, wherein the first pipe and the second pipe are substantially disposed in parallel with each other.

3. The heat exchanging apparatus according to claim 1, further comprising:
a flow passage element disposed on one side of the first pipe and the second pipe relative to the water-collecting tank, and comprising a first flow passage, wherein the first pipe is communicated with the second pipe through the first flow passage.

4. The heat exchanging apparatus according to claim 1, wherein the water-collecting tank comprises:
a first sub-water-collecting tank communicated with the first pipe, wherein the first pipe is adapted to receive the vapor produced by the cathode through the first sub-water-collecting tank.

5. The heat exchanging apparatus according to claim 1, wherein the first pipe comprises a plurality of segments, and the first channel is capable of sequentially passing through the segments.

6. The heat exchanging apparatus according to claim 1, wherein the first channel is communicated with the second channel, for receiving the airflow heated by the second pipe.

7. The heat exchanging apparatus according to claim 1, wherein an outer surface of the second pipe comprises a plurality of fins.

8. The heat exchanging apparatus according to claim 1, wherein an inner surface of the first pipe comprises a capillary structure.

9. The heat exchanging apparatus according to claim 1, wherein an inner surface of the second pipe comprises a capillary structure.

10. The heat exchanging apparatus according to claim 1, wherein the airflow generator is an axial fan.

11. The heat exchanging apparatus according to claim 1, further comprising:
at least one third pipe communicated with the second pipe through the water-collecting tank; and
at least one fourth pipe communicated between the third pipe and the water-collecting tank.

12. The heat exchanging apparatus according to claim 11, wherein the first pipe, the second pipe, the third pipe, and the fourth pipe are substantially disposed in parallel with one another.

13. The heat exchanging apparatus according to claim 11, wherein an inner surface of the third pipe comprises a capillary structure.

14. The heat exchanging apparatus according to claim 11, wherein an inner surface of the fourth pipe comprises a capillary structure.

15. The heat exchanging apparatus according to claim 11, further comprising:
a flow passage element disposed on one side of the first pipe, the second pipe, the third pipe, and the fourth pipe relative to the water-collecting tank, and comprising a first flow passage and a second flow passage, wherein the first pipe is communicated with the second pipe through the first flow passage, and the third pipe is communicated with the fourth pipe through the second flow passage.

16. The heat exchanging apparatus according to claim 11, wherein the water-collecting tank comprises:
a second sub-water-collecting tank, wherein the second pipe is communicated with the third pipe through the second sub-water-collecting tank; and
a third sub-water-collecting tank communicated with the fourth pipe, and comprising the fluid outlet.

17. The heat exchanging apparatus according to claim 11, wherein the third pipe and the fourth pipe are disposed in the second channel.

18. The heat exchanging apparatus according to claim 17, wherein the first channel is communicated with the second channel, for receiving the airflow heated by the second pipe, the third pipe, and the fourth pipe.

19. The heat exchanging apparatus according to claim 1, further comprising:
a water-storage tank disposed between the water-collecting tank and the fuel-mixing tank, located below the water-collecting tank, and communicated between the water-collecting tank and the fuel-mixing tank.

20. The heat exchanging apparatus according to claim 19, further comprising:
a blocking element disposed between the water-collecting tank and the water-storage tank, for allowing the liquid water in the water-collecting tank to pass through the blocking element and flow to the water-storage tank, and blocking the vapor in the water-collecting tank from flowing to the water-storage tank.
